(19) United States
(12) Patent Application Publication
(10) Pub. No.: US 2020/0295353 A1
(43) Pub. Date: Sep. 17, 2020

(54) ELECTRODE SHEET MANUFACTURING METHOD

(71) Applicant: TOYOTA JIDOSHA KABUSHIKI KAISHA, Toyota-shi (JP)

(72) Inventor: Yukiko TANAKA, Miyoshi-shi (JP)

(21) Appl. No.: 16/811,826

(22) Filed: Mar. 6, 2020

(30) Foreign Application Priority Data
Mar. 13, 2019 (JP) 2019-046358

(51) Int. Cl. H01M 4/139; H01M 4/04

(52) U.S. Cl. CPC H01M 4/139; H01M 4/0404; H01M 4/043; H01M 4/0471

(57) ABSTRACT

An electrode sheet manufacturing method includes a first applying step, a second applying step, and a heating-pressing step. In the first and the second applying step, an electrode mixture material is applied on a first surface of a current collector foil. In the first applying step, the backup roll is rotated while being in contact with a second surface of the current collector foil, and the supplying roll is rotated while being supplied with the electrode mixture material in a powder state on the surface of the supplying roll. In addition, a potential difference is produced between these rolls, and the electrode mixture material is moved from the supply roll to the first surface of the current collector foil by an electrostatic force acting between the electrode mixture material and the current collector foil.

### INCORPORATION BY REFERENCE

The disclosure of Japanese Patent Application No. 2019-046358 filed on Mar. 13, 2019 including the specification, drawings and abstract is incorporated herein by reference in its entirety.

### BACKGROUND

### 1. Technical Field

The present disclosure relates to an electrode sheet manufacturing method. More specifically, the present disclosure relates to an electrode sheet manufacturing method for manufacturing an electrode sheet by forming an electrode mixture layer on a surface of a current collector foil while conveying the current collector foil.

### 2. Description of Related Art

Some rechargeable batteries such as lithium ion rechargeable batteries have positive and negative electrode sheets thereinside. Specifically, for example, positive and negative electrode sheets are stacked by being wound or flat-stacked with separators interposed between them, and then are housed in cases. An example of the manufacturing method of the above electrode sheet of related art may include, for example, Japanese Patent Application Publication No. 2016-119207 (JP 2016-119207 A).

JP 2016-119207 A describes that an electrode mixture layer is formed by supplying and depositing particles used for forming an electrode mixture layer on a current collector foil, and then pressing the layer of the deposited particles in the thickness direction.

### SUMMARY

Meanwhile, in the above related art, granulated particles are used as particles used for forming the electrode mixture layer. Granulated particles are produced by kneading an active material and a binder, which are powder materials for forming the electrode mixture layer, with a solvent as a liquid component, and the like, and the granulated particles therefore contain the solvent.

However, the solvent is an unnecessary component in a finished electrode sheet. Hence, when granulated particles containing the solvent are used, drying for removing the solvent is required in a subsequent step, and the drying step may take a long time. Consequently, the related art has such a problem that the manufacture efficiency of the electrode sheet becomes deteriorated.

The present disclosure has been made for the purpose of solving the above-described problem of the related art. The present disclosure provides a manufacturing method of an electrode sheet which can efficiently manufacture a high-quality electrode sheet.

An electrode sheet manufacturing method of the present disclosure, which has been made for the purpose of solving the above problems, is an electrode sheet manufacturing method manufacturing an electrode sheet by forming an electrode mixture layer on a surface of a current collector foil while conveying the current collector foil, the electrode mixture layer made of an electrode mixture material including at least an active material and a binder, the electrode sheet manufacturing method including: an applying step of applying the electrode mixture material on a formation surface that is a surface of the current collector foil on which the electrode mixture layer is formed; and a heating-pressing step of heating and pressing a layer of the electrode mixture material applied on the formation surface in a thickness direction of the layer of the electrode mixture material. In the applying step, by means of a backup roll and a supply roll, the backup roll rotating and in contact with a back surface of the current collector foil opposite to the formation surface of the current collector foil, the supply roll facing the backup roll with the current collector foil interposed between the supply roll and the backup roll, the supply roll arranged with a gap between the formation surface and the supply roll, the supply roll is rotated while the electrode mixture material is supplied in a powder state on a surface of the supply roll, a potential difference is produced between the backup roll and the supply roll, and the electrode mixture material is moved from the surface of the supply roll to the formation surface by an electrostatic force acting between the electrode mixture material and the current collector foil so as to apply the electrode mixture material on the formation surface. The applying step is performed multiple times before the heating-pressing step.

In the electrode sheet manufacturing method according to the present disclosure, the electrode mixture material can be applied in a powder state on the formation surface of the current collector foil. That is, unlike the case of the related art, a material that does not contain a solvent can be used, so that a step for removing the solvent can be eliminated. Further, by performing the applying step multiple times, it is possible to apply a sufficient amount of the electrode mixture material on the current collecting foil while increasing the conveying speed of the current collecting foil. Thereby, a high-quality electrode sheet can be manufactured efficiently.

In the above electrode sheet manufacturing method according to the present disclosure, of the multiple applying steps, in the applying step performed last time, an active material having a smaller average particle diameter than that used in the applying step performed before the applying step performed last time may be used as the active material. This is because a higher quality electrode sheet can be manufactured in which the average particle diameter of the active material present near the surface of the electrode mixture layer is small.

According to the present disclosure, provided is the electrode sheet manufacturing method which can efficiently manufacture a high-quality electrode sheet.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a sectional view of an electrode sheet according to an embodiment;

FIG. 2 is a schematic configuration view of an electrode manufacturing apparatus according to an embodiment; and

FIG. 3 is a view showing powder of an electrode mixture material in a stirring container of the electrode manufacturing apparatus.

### DETAILED DESCRIPTION OF EMBODIMENTS

Hereinafter, best modes for embodying the present disclosure will be described in detail with reference to the drawings.

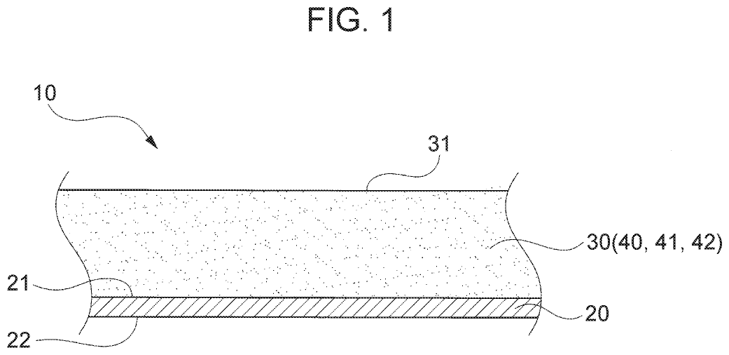

First, an electrode sheet manufactured by the manufacturing method according to the present embodiment will be described. FIG. 1 is a sectional view of an electrode sheet 10 according to the present embodiment. The electrode sheet 10 has a sheet-like shape as a whole having its longitudinal direction in the left-right direction. The electrode sheet 10 has a current collector foil 20 and an electrode mixture layer 30 in the thickness direction that is the height direction in FIG. 1. The above-configured electrode sheet 10 is used as an electrode of a rechargeable battery, for example. In the present embodiment, the electrode sheet 10 used as a negative electrode of a lithium ion rechargeable battery will be described.

The current collector foil 20 has a first surface 21 that is one surface in the thickness direction and a second surface 22 that is a back surface of the first surface 21.

In the electrode sheet 10 of the present embodiment that is a negative electrode of a lithium ion rechargeable battery, a copper foil can be used as the current collector foil 20, for example.

The electrode mixture layer 30 is provided so as to cover the first surface 21 of the current collector foil 20. In FIG. 1, the surface of the electrode mixture layer 30 farther from the current collector foil 20 is shown as an electrode mixture layer surface 31. The electrode mixture layer 30 is made of an electrode mixture material 40. As the electrode mixture material 40, the electrode mixture layer 30 of the present embodiment includes at least an active material 41 and a binder 42.

The active material 41 is a material that can occlude and release lithium ions. The binder 42 is a material used for forming the electrode mixture layer 30 by causing mutual binding in the active material 41. and also binding the electrode mixture layer 30 onto the first surface 21 of the current collector foil 20. In the electrode sheet 10 of the present embodiment, which is the negative electrode of the lithium ion rechargeable battery, graphite can be used as the active material 41 and PVdF can be used as the binder 42, for example.

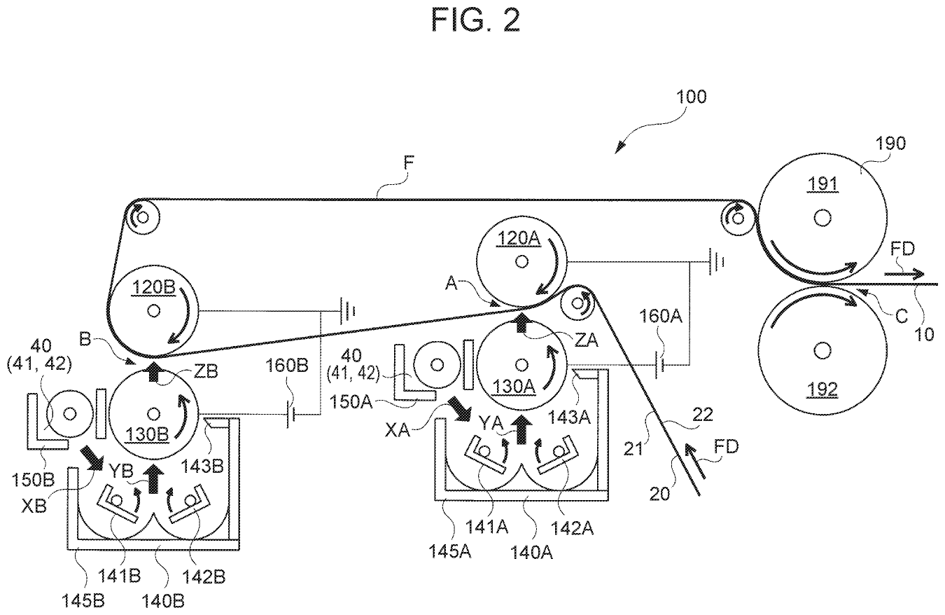

Next, the manufacturing method of the electrode sheet 10 will be described. FIG. 2 is a schematic configuration view of an electrode manufacturing apparatus 100 capable of manufacturing the electrode sheet 10 of the present embodiment.

As shown in FIG. 2, the electrode manufacturing apparatus 100 can manufacture the electrode sheet 10 while conveying the elongate current collector foil 20 in the longitudinal direction. In FIG. 2, the current collector foil 20 is supplied to the electrode manufacturing apparatus 100 from the lower right side. In the present embodiment, the first surface 21 of the current collector foil 20 being supplied to the electrode manufacturing apparatus 100 is not yet formed with anything, and thus the first surface 21 is exposed. While conveying the current collector foil 20 along a conveyance path F, the electrode manufacturing apparatus 100 discharges the current collector foil 20 from the upper right side as the electrode sheet 10 having the electrode mixture layer 30 formed on the first surface 21 thereof. Further, on the conveyance path F of the current collector foil 20 being conveyed in the electrode manufacturing apparatus 100, a first applying position A, a second applying position B, and a heating-pressing position C are provided in this order from upstream to downstream in a conveyance direction FD.

In the first applying position A, a backup roll 120A and a supply roll 130A are provided to face each other with the current collector foil 20 interposed therebetween. The backup roll 120A rotates in a direction indicated by an arrow shown in FIG. 2 (clockwise) while the outer peripheral surface thereof is in contact with the second surface 22 of the current collector foil 20. Thereby, the current collector foil 20 can be conveyed. The supply roll 130A rotates in a direction indicated by an arrow shown in FIG. 2 (counterclockwise) while the outer peripheral surface thereof is out of contact with the first surface 21 of the current collector foil 20. That is, the supply roll 130A is arranged with a gap between the current collector foil 20 and the supply roll 130A. Further, the supply roll 130A of the present embodiment is a magnet roll that can attract a ferromagnetic material.

A power supply 160A is electrically connected to the backup roll 120A and the supply roll 130A. Accordingly, the power supply 160A can produce a potential difference between the backup roll 120A and the supply roll 130A.

A stirring unit 140A is provided below the supply roll 130A. The stirring unit 140A can stir an object accommodated in a stirring container 145A by rotation of stirring blades 141A, 142A. A squeegee 143A that protrudes toward the supply roll 130A is provided at an upper right part of the stirring container 145A. The front end of the squeegee 143A is out contact with the supply roll 130A, and a gap is provided between the squeegee 143A and the supply roll 130A.

A powder feeding unit 150A is provided on the upper left side of the stirring unit 140A. The powder feeding unit 150A is a unit into which the electrode mixture material 40 is fed. The active material 41 and the binder 42 as the electrode mixture material 40 are fed in a powder state into the powder feeding unit 150A. In the present embodiment, the electrode mixture material 40 in a state of containing no solvent is fed into the powder feeding unit 150A.

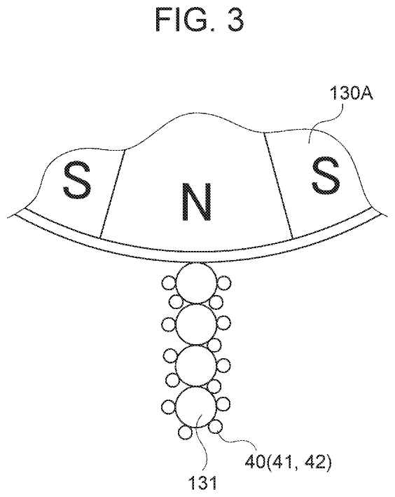

The powder feeding unit 150A is configured to feed the powder of the fed electrode mixture material 40 into the stirring container 145A from below, as indicated by an arrow XA. Hence, the powder of the electrode mixture material 40 is accommodated in the stirring container 145A. FIG. 3 is a view showing the powder of the electrode mixture material 40 in the stirring container 145A. FIG. 3 also shows the supply roll 130A disposed above the stirring unit 140A. Further, as shown in FIG. 3, carrier particles 131 are also accommodated in the stirring container 145A. The carrier particles 131 are ferromagnetic particles. As the carrier particles 131, ferrite particles can be used, for example.

Some of the carrier particles 131 in the stirring container 145A adhere to the supply roll 130A that is a magnet roll, as shown in FIG. 3. In addition, the particles of the electrode mixture material 40 being stirred in the stirring container 145A adhere to the carrier particles 131. The electrode mixture material 40 adheres to the carrier particles 131 due to the van der Waals force or by being caught on the carrier particles 131.

Specifically, as indicated by an arrow YA in FIG. 2, the powder of the electrode mixture material 40 in the stirring container 145A adheres to the supply roll 130A via the carrier particles 131. In addition, as described above, the supply roll 130A is rotated in the direction indicated by the arrow in FIG. 2. Hence, the carrier particles 131 and the electrode mixture material 40 adhering to the supply roll 130A reach the squeegee 143A provided with a gap between the supply roll 130A and the squeegee 143A by the rotation of the supply roll 130A. The squeegee 143A can level the carrier particles 131 and the electrode mixture material 40 on the supply roll 130A passing the squeegee 143A. That is, the carrier particles 131 and the electrode mixture material 40 on the supply roll 130A having reached the squeegee 143A are leveled as passing through the gap between the supply roll 130A and the squeegee 143A, to thereby adjust the adhesion amount thereof to be constant.

The carrier particles 131 and the electrode mixture material 40 whose adhesion amount to the supply roll 130A is adjusted at a constant level reach the first applying position A as the supply roll 130A further rotates. At the first applying position A, a potential difference is produced between the backup roll 120A and the supply roll 130A by the power supply 160A. Consequently, a potential difference is also produced between the current collector foil 20 in contact with the backup roll 120A and the powder of the electrode mixture material 40 adhering to the supply roll 130A. Accordingly, at the first applying position A, an electrostatic force acts between the current collector foil 20 and the power of the electrode mixture material 40.

A tension for the conveyance is applied to the current collector foil 20, and by the tension, a pushing force is applied to the current collector foil 20 at the first applying position A in a direction of pushing the current collector foil 20 against the backup roll 120A. On the other hand, the adhesion strength of the powder of the electrode mixture material 40 onto the supply roll 130A is caused due to the van der Waals force or by being caught on the carrier particles 131 as described above. That is, the adhesion strength of the powder of the electrode mixture material 40 onto the supply roll 130A is weaker than the pushing force of the current collector foil 20 against the backup roll 120A. Therefore, at the first applying position A, due to the electrostatic force acting between the current collector foil 20 and the powder of the electrode mixture material 40, the powder of the electrode mixture material 40 jumps to move from the supply roll 130A to the first surface 21 of the current collector foil 20, as indicated by an arrow ZA. Thereby, at the first applying position A, the powder of the electrode mixture material 40 can be caused to adhere and be applied on the first surface 21 of the current collector foil 20.

The carrier particles 131 on the supply roll 130A remain on the supply roll 130A due to an attractive force generated by a magnetic force of the supply roll 130A. That is, the electrostatic force acting in the direction of the arrow ZA on the carrier particles 131 at the first applying position A is weaker than the attractive force caused by the magnetic force of the supply roll 130A. The carrier particles 131 remaining on the supply roll 130A are then returned to the stirring container 145A by the rotation of the supply roll 130A. Alternatively, the carrier particles 131 adhering on the supply roll 130A passes through the squeegee 143A and the first applying position A again, while allowing the powder of the electrode mixture material 40 to adhere thereon.

At the second applying position B, the same configuration as that at the first applying position A is employed. That is, at the second applying position B, a backup roll 120B and a supply roll 130B are also provided to face each other with the current collector foil 20 interposed therebetween. A power supply 160B is electrically connected to the backup roll 120B and the supply roll 130B so as to produce a potential difference therebetween. A stirring unit 140B is provided below the supply roll 130B, and a powder feeding unit 150B is provided on the upper left side of the stirring unit 140B. Also in the powder feeding unit 150B, the electrode mixture material 40 in a powder state of containing no solvent is fed.

Then, the powder of the electrode mixture material 40 fed in the powder feeding unit 150B is supplied into a stirring container 145B as indicated by an arrow XB. The electrode mixture material 40 supplied from the powder feeding unit 150B into the stirring container 145B is stirred by the rotating stirring blades 141B, 142B, and is moved to the supply roll 1309 to which the carrier particles 131 adhere, as indicated by an arrow YB. The powder of the electrode mixture material 40 adhering to the supply roll 1309 reaches the second applying position B after the adhesion amount thereof is adjusted by the squeegee 143B by the rotation of the supply roll 130B.

At the second applying position B, a potential difference is produced between the current collector foil 20 on the backup roll 120B side and the powder of the electrode mixture material 40 on the supply roll 130B side by the power supply 160B. The electrode mixture material 40 moves from the supply roll 130B side toward the current collector foil 20 side, as indicated by an arrow ZB by an electrostatic force acting due to this potential difference. That is, also at the second applying position B, the electrode mixture material 40 can be caused to adhere and applied onto the first surface 21 side of the current collector foil 20. As described above, at the second applying position B, since the same configuration as that at the first applying position A is provided, the electrode mixture material 40 can be applied onto the first surface 21 of the current collector foil 20, as with the first applying position A.

The powder of the electrode mixture material 40 applied on the current collector foil 20 at the first applying position A and at the second applying position B can be caused to adhere to the first surface 21 of the current collector foil 20 by the van der Waals force. Therefore, the electrode mixture material 40 can be held on the first surface 21 even when the first surface 21 of the current collector foil 20 faces downward in the gravity direction.

A hot press roll pair 190 is provided at a heating-pressing position C located more downstream than the second applying position B in the conveyance direction FD of the current collector foil 20. The hot press roll pair 190 includes a first hot press roll 191 and a second hot press roll 192 that are provided to face each other. That is, the heating-pressing position C is a position where the first hot press roll 191 and the second hot press roll 192 face each other.

The first hot press roll 191 and the second hot press roll 192 are arranged with a predetermined distance therebetween at the heating-pressing position C. The dimension of the gap between the hot press roll pair 190 is smaller than a total combined thickness of the thickness of the current collector foil 20 and the thickness of the powder layer of the electrode mixture material 40 on the first surface 21 at a position before passing through the heating-pressing position C. Therefore, as passing through the heating-pressing position C, the powder layer of the electrode mixture material 40 adhering on the first surface 21 of the current collector foil 20 is pressed together with the current collector foil 20 in the thickness direction.

The hot press roll pair 190 may have any configuration as long as the hot press roll pair 190 can press, in the thickness direction, the current collector foil 20 and the powder layer of the electrode mixture material 40 on the first surface 21 of the current collector foil 20 when they pass through the heating-pressing position C. Therefore, the hot press roll pair 190 may be configured such that a pushing force oriented in the opposite direction may be applied to at least one of the first hot press roll 191 and the second hot press roll 192.

In addition, at least one of the first hot press roll 191 and the second hot press roll 192 can be heated by a heating source. This heating temperature is set at a temperature at which the binder 42 passing through the heating-pressing position C is softened or melted. That is, the heating temperature is set at a temperature at which the binding action is caused in the binder 42. Therefore, the current collector foil 20 and the powder of the electrode mixture material 40 adhering on first surface 21 of the current collector foil 20 are heated as they pass through the heating-pressing position C.

At the heating-pressing position C, as the electrode mixture material 40 is pressed while being heated, mutual binding is caused in the active material 41 on the first surface 21 of the current collector foil 20 by the binder 42. Thereby, the electrode mixture layer 30 is formed. The electrode mixture layer 30 is bound onto the first surface 21 of the current collector foil 20 by the binder 42. That is, the current collector foil 20 to which the powder of the electrode mixture material 40 adheres passes through the heating-pressing position C, to be formed into the electrode sheet 10.

In the present embodiment, the following three steps can be performed in this order by manufacturing the electrode sheet 10 using the above-described electrode manufacturing apparatus 100: 1, a first applying step; 2. a second applying step; and 3. a heating-pressing step 3.

That is, the current collector foil 20 having been conveyed to the electrode manufacturing apparatus 100 first reaches the first applying position A. Then, at the first applying position A, “1. the first applying step” of applying the electrode mixture material 40 on the first surface 21 of the current collector foil 20 is performed.

Specifically, an outer peripheral surface of the supply roll 130A provided below the first applying position A is supplied with the electrode mixture material 40 in a power state by the stirring unit 140A from the lower side different from the upper side facing the first surface 21 of the current collector foil 20. The electrode mixture material 40 supplied to the supply roll 130A is leveled as the electrode mixture material 40 passes through the squeegee 143A by the rotation of the supply roll 130A, and thereafter, faces the current collector foil 20 positioned at the first applying position A.

Further, a potential difference is produced between the backup roll 120A and the supply roll 130A by the power supply 160A. Therefore, an electrostatic force acts between the current collector foil 20 in contact with the second surface 22 of the backup roll 120A and the electrode mixture material 40 adhering to the supply roll 130A. The electrostatic force causes the electrode mixture material 40 to move from the supply roll 130A to the first surface 21 of the current collector foil 20. Thereby, at the first applying position A, “1. the first applying step” is performed in which the electrode mixture material 40 is applying on the first surface 21 of the current collector foil 20.

The current collector foil 20 after passing through the first applying position A then reaches the second applying position B. Subsequently, at the second applying position B, “2. the second applying step” is performed in which the electrode mixture material 40 is applied on the first surface 21 of the current collector foil 20.

Also in “2. the second applying step” performed at the second applying position B, the applying method of applying the electrode mixture material 40 itself is the same as that in “1, the first applying step”. However, in “2. the second applying step” performed at the second applying position B, the electrode mixture material 40 is applied on the first surface 21 of the subsequent current collector foil 20 on which the electrode mixture material 40 has already been applied in “1. the first applying step” having been performed at the first applying position A. That is, in “2. the second applying step”, the electrode mixture material 40 is applied to be overlaid on the first surface 21 of the current collector foil 20 to which the electrode mixture material 40 has already been applied.

The current collector foil 20 after passing through the second applying position B then reaches the heating-pressing position C. At the heating-pressing position C, “3. the heating-pressing step” is performed in which heating and pressing are performed on the current collector foil 20 and the layer of the electrode mixture material 40 applied on the first surface 21 of the current collector foil 20.

Specifically, at the heating-pressing position C, the current collector foil 20 and the layer of the electrode mixture material 40 applied on the first surface 21 of the current collector foil 20 pass through between the first hot press roll 191 and the second hot press roll 192. When passing therethrough, the current collector foil 20 and the layer of the electrode mixture material 40 disposed on the first surface 21 of the current collector foil 20 are pressed in the thickness direction thereof. Furthermore, at least one of the first hot press roll 191 and the second hot press roll 192 is heated by a heating source. Hence, at the heating-pressing position C, the current collector foil 20 and the layer of the electrode mixture material 40 disposed on the first surface 21 of the current collector foil 20 are heated.

Accordingly, the layer of the electrode mixture material 40 disposed on the first surface 21 of the current collector foil 20 is set to have an appropriate thickness and is fixed onto the first surface 21 with the binding action of the binder 42. Thereby, it is possible to manufacture the electrode sheet 10 with the electrode mixture layer 30 formed on the first surface 21 of the current collector foil 20.

Here, in the manufacturing method of the electrode sheet 10 of the present embodiment, it is unnecessary to use a solvent for forming the electrode mixture layer 30. That is, as the powder of the electrode mixture material 40 supplied to the surface of the supply roll 130A, power containing no solvent can be used. Accordingly, it is unnecessary to remove the solvent later, and the electrode sheet 10 can be manufactured without requiring a special drying step, for example. That is, it is possible to efficiently manufacture the electrode sheet 10.

In the present embodiment, as the step of applying the electrode mixture material 40 on the first surface 21 of the current collector foil 20, the first applying step and the second applying step are performed. That is, the applying step of applying the electrode mixture material 40 on the first surface 21 of the current collector foil 20 is performed twice. Accordingly, the high-quality electrode sheet 10 can be manufactured efficiently.

In the electrode sheet 10, it is not preferable for the electrode mixture layer 30 to have an excessively thin thickness. This is because there is such a problem that may cause decrease in full charge capacity of a rechargeable battery manufactured using the electrode sheet 10, or the like. That is, generally, in order to manufacture a high-quality rechargeable battery, the electrode mixture layer 30 in the electrode sheet 10 needs to have a certain thickness.

For example, when the applying step is completed once, the electrode mixture material 40 with amount sufficient to form the electrode mixture layer 30 having a desired thickness is applied on the first surface 21 of the current collector foil 20 through the only one applying step. In this case, in the applying step, it is required to provide a sufficient supply amount of the electrode mixture material 40 with respect to the conveyance speed of the current collector foil 20. Specifically, for example, in order to apply the electrode mixture material 40 with sufficient amount to form the electrode mixture layer 30 having a desired thickness at the first applying position A, there is a method to set the peripheral speed of the supply roll 130A faster than the peripheral speed of the present embodiment.

Meanwhile, in order to increase the peripheral speed of the supply roll 130A, as the rotational speed of the supply roll 130A increases, a stronger centrifugal force is applied to the electrode mixture material 40 adhering to the supply roll 130A. On the other hand, as described above, the adhesion strength of the power of the electrode mixture material 40 to the supply roll 130A is caused due to the van der Waals force or by being caught on the carrier particles 131, and thus this is not so strong. Hence, the supply amount of the electrode mixture material 40 to the first applying position A is not necessarily increased in proportion to the rotation speed of the supply roll 130A. That is, an excessively high rotation speed of the supply roll 130A rather causes increase in amount of the electrode mixture material 40 that has once adhered to the supply roll 130A and then comes off and scatters away from the supply roll 130A. Hence, an excessively high rotation speed of the supply roll 130A cannot increase the supply amount of the electrode mixture material 40 to the first applying position A so much. In other words, increase in peripheral speed of the supply roll 130A results in increase in scattering amount of the electrode mixture material 40, which may deteriorate the productive efficiency of the electrode sheet 10.

For example, the applying amount of the electrode mixture material 40 at the first applying position A can be increased by lowering the conveyance speed of the current collector foil 20. However, if the conveyance speed of the current collector foil 20 is lowered, the productivity of the electrode sheet 10 is lowered, accordingly,

To counter this, in the present embodiment, the applying step of applying the electrode mixture material 40 on the first surface 21 of the current collector foil 20 is performed twice. That is, the electrode mixture material 40 with sufficient amount to form the electrode mixture layer 30 having a desired thickness is applied on the first surface 21 of the current collector foil 20 in two steps. Therefore, in each of the first applying step and the second applying step, the amount of the electrode mixture material 40 applied on the first surface 21 of the current collector foil 20 can be smaller than the amount of the electrode mixture material 40 required for forming the electrode mixture layer 30 having a desired thickness. That is, the conveyance speed of the current collector foil 20 can be maintained at a high level while the supply roll 130A and the supply roll 130B are set to have appropriate rotation speeds without having excessively high rotation speeds. Accordingly, in the manufacturing method of the electrode sheet 10 of the present embodiment, it is possible to efficiently manufacture the high-quality electrode sheet 10 having the electrode mixture layer 30 with a sufficient thickness.

In the manufacturing method of the electrode sheet 10 of the present embodiment using the electrode manufacturing apparatus 100, the applying step of applying the powder of the electrode mixture material 40 on the first surface 21 of the current collector foil 20 is performed twice: the first applying step; and the second applying step. Thus, as the electrode mixture material 40, different materials can be used respectively in the first applying step and the second applying step.

In the second applying step, the powder of the electrode mixture material 40 is applied in the state in which the powder of the electrode mixture material 40 is already present on the first surface 21 of the current collector foil 20 in the first applying step. Therefore, in the electrode mixture layer 30 of the electrode sheet 10, more of the electrode mixture material 40 applied in the first applying step is present near the first surface 21 of the current collector foil 20, and more of the electrode mixture material 40 applied in the second applying step is present near the electrode mixture layer surface 31.

In the electrode sheet 10, it is likely to be preferable that particles of the active material 41 present near the electrode mixture layer surface 31 of the electrode mixture layer 30 have small particle diameters. For example, in a lithium ion rechargeable battery in which an electrolytic solution is contained together with the electrode sheet 10 in the case, the smaller the particle diameters of the particles of the active material 41 present near the electrode mixture layer surface 31, the greater the contact area between the electrolytic solution and the particles of the active material 41 can be. Accordingly, it is likely to enhance the acceptability of lithium ion of the electrode mixture layer 30, to thereby produce a lithium ion rechargeable battery with a high quality.

Therefore, in the manufacturing method of the electrode sheet 10 of the present embodiment, as the active material 41 in the electrode mixture material 40 used in the second applying step, it is preferable to use an active material having a smaller average particle diameter than that of the active material 41 used in the first applying step. Specifically, for example, in the electrode manufacturing apparatus 100, it is conceivable that the average particle diameter of the powder of the active material 41 fed into the powder feeding unit 150B according to the second applying step is set to be about ½ of the average particle diameter of the powder of the active material 41 fed into the powder feeding unit 150A according to the first applying step. As described above, the electrode sheet 10 used for producing a high-quality rechargeable battery can be manufactured by using, as the active material 41 used in the second applying step, a material having a smaller average particle diameter than that of the active material 41 used in the first applying step. In the present embodiment, the average particle diameter is defined based on the median diameter that is a particle diameter of an integrated value of 50% in the particle size distribution based on the volume standard, obtained by the laser diffraction-scattering method.

Moreover, in the manufacturing method of the electrode sheet 10 using the above-described electrode manufacturing apparatus 100, the applying step in which the powder of the electrode mixture material 40 is applied on the first surface 21 of the current collector foil 20 is performed twice (in the first applying step and the second applying step). However, the applying step may be performed three or more times. That is, the applying step may be performed multiple times before the heating-pressing step. When performing the applying step three times, it may be configured to use the active material having a smaller average particle diameter in the third applying step than those used in the first and the second applying steps. That is, when the applying step is performed multiple times, in the last applying step of the multiple times, it may be configured to use such an active material that has a smaller average particle diameter than those used in the applying step performed before the last time. This is because it is possible to manufacture a high-quality electrode sheet in which more of the active material having a smaller particle diameter is applied on the surface of the electrode mixture layer.

As described above in detail, in the manufacturing method of the electrode sheet 10 according to the present embodiment, the applying step and the heating-pressing step are performed. In the applying step, the electrode mixture material 40 is applied on the first surface 21 that is the surface of the current collector foil 20 on which the electrode mixture layer 30 is formed. In the heating-pressing step, the layer of the electrode mixture material 40 applied on the first surface 21 of the current collector foil 20 is pressed in its thickness direction while being heated. Further, as the applying step, the first applying step and the second applying step are performed. In the first applying step, the backup roll 120A and the supply roll 130A are used. The backup roll 120A is rotated while being in contact with the second surface 22 of the current collector foil 20 so as to convey the current collector foil 20. The supply roll 130A is rotated while being supplied with the electrode mixture material 40 in a powder state on the surface of the supply roll 130A. In addition, a potential difference is produced between the backup roll 120A and the supply roll 130A. Thereby, a potential difference is produced between the electrode mixture material 40 and the current collector foil 20, and using an electrostatic force acting therebetween, the electrode mixture material 40 is moved from the surface of the supply roll 130A to the first surface 21 of the current collector foil 20. In this manner, in the first applying step, the electrode mixture material 40 is applied on the first surface 21 of the current collector foil 20. The same applies to the second applying step performed after the first applying step. Thus, the electrode sheet 10 having the electrode mixture layer 30 with a sufficient thickness is efficiently manufactured. Accordingly, the electrode sheet manufacturing method capable of efficiently manufacturing a high-quality electrode sheet is realized.

Note that the present embodiment is merely exemplified and does not limit the present disclosure at all. Therefore, the present disclosure can naturally be improved and modified in various manners without departing from the gist thereof. For example, in the above embodiment, the description has been provided on the example in which the present disclosure is applied to a negative electrode of a lithium ion rechargeable battery. However, the present disclosure can also be applied to a positive electrode. For example, in the above embodiment, the description has been provided on the example in which the present disclosure is applied to an electrode sheet used as a negative electrode of a lithium ion rechargeable battery. However, the present disclosure can be applied not only to electrode sheets used for lithium ion rechargeable batteries but also to electrode sheets used for rechargeable batteries of other types. In the above description, the description has been provided on the example in which the active material and the binder are used as the electrode mixture material; however, for example, materials such as a conductive aiding material may be added as appropriate for the purpose of enhancing the conductivity in the electrode mixture layer.

Further, for example, in the above-described embodiment, it has been described that the heating-pressing step that pressing the layer of the electrode mixture material disposed on the current collector foil while heating this layer is performed by carrying out the heating and the pressing simultaneously using the pair of hot press rolls. However, for example, in the heating-pressing step, it may be configured to heat the layer of the electrode mixture material disposed on the current collector foil, and then press the heated layer of the electrode mixture material before the temperature of this heated layer is lowered to a temperature at which the binding action of the binder is not caused.

Moreover, for example, in the above-described embodiment, the description has been provided specifically on the manufacturing method of the electrode sheet having the electrode mixture layer on only one surface of the current collector foil. However, the electrode sheet may have the electrode mixture layers on both the front and back surfaces. When the electrode sheet having the electrode mixture layers on both sides of the current collector foil are manufactured, a set of the applying step and the heating-pressing step described in the above embodiment may be performed twice, respectively on the front side and the back side of the current collector foil.

What is claimed is:

1. An electrode sheet manufacturing method manufacturing an electrode sheet by forming an electrode mixture layer on a surface of a current collector foil while conveying the current collector foil, the electrode mixture layer made of an electrode mixture material including at least an active material and a binder,
the electrode sheet manufacturing method comprising:
an applying step of applying the electrode mixture material on a formation surface that is a surface of the current collector foil on which the electrode mixture layer is formed; and
a heating-pressing step of heating and pressing a layer of the electrode mixture material applied on the formation surface in a thickness direction of the layer of the electrode mixture material, wherein
in the applying step,
by means of a backup roll and a supply roll, the backup roll rotating and in contact with a back surface of the current collector foil opposite to the formation surface of the current collector foil, the supply roll facing the backup roll with the current collector foil interposed between the supply roll and the backup roll, the supply roll arranged with a gap between the formation surface and the supply roll,
the supply roll is rotated while the electrode mixture material is supplied in a powder state on a surface of the supply roll, a potential difference is produced between the backup roll and the supply roll, and the electrode mixture material is moved from the surface of the supply roll to the formation surface by an electrostatic force acting between the electrode mixture material and the current collector foil so as to apply the electrode mixture material on the formation surface, and
the applying step is performed multiple times before the heating-pressing step.

2. The electrode sheet manufacturing method according to claim 1, wherein, of the multiple applying steps, in the applying step performed last time, an active material having a smaller average particle diameter than that used in the applying step performed before the applying step performed last time is used as the active material.
